(19) United States
(12) Patent Application Publication
(10) Pub. No.: US 2018/0340864 A1
(43) Pub. Date: Nov. 29, 2018

(54) FOUR-STATION ROAD VEHICLE WHEEL RADIAL FATIGUE TEST DEVICE AND METHOD

(71) Applicants: CITIC Dicastal CO.,LTD., Qinhuangdao (CN); CITIC Bohai Aluminum Industries Holding Limited, Qinhuangdao (CN)

(72) Inventor: Liqun Zheng, Qinhuangdao (CN)

(21) Appl. No.: 15/710,015

(22) Filed: Sep. 20, 2017

(30) Foreign Application Priority Data
May 24, 2017 (CN) 201710372705.X

(51) Int. Cl. G01M 17/013

(52) U.S. Cl. CPC G01M 17/013

(57) ABSTRACT

The invention provides a four-station road vehicle wheel radial fatigue test device and method. The device includes wheel and tire assemblies, wheel and tire assembly supporting and loading devices, a drum and a bracket. The device can realize simultaneous test on four test stations, thereby improving the utilization rate of equipment, and increasing the test efficiency. By adopting the vertical drum, the size and occupation area of the test device are reduced, and the wheel and tire assemblies are more convenient to install and remove. By adopting the servo motor as a power source for the drum and the wheel and tire assembly supporting and loading devices, the rotating speed and the load are easier to control, and the accuracy is higher.

### CROSS-REFERENCE TO RELATED APPLICATIONS

This application is filed based upon and claims priority to Chinese Patent Application No. 201710372705.X, filed on May 24, 2017, the entire contents of which are incorporated herein by reference.

### BACKGROUND

The four-station road vehicle wheel radial fatigue test device is a detection device special for detecting the fatigue reliability of road vehicle wheels. Generally, in order to ensure the running safety reliability of a road vehicle wheel, its radial fatigue performance needs to be tested, i.e., its reliability is tested by adopting a special detection device to simulate the continuous running state of wheel and tire assemblies. Thus, a test device for detecting the reliability of the road vehicle wheel is needed.

The road vehicle wheel radial fatigue test requires charging compressed air of certain pressure to the wheel and tire assemblies first, and then installing the assemblies onto a special test device, which needs to provide the assemblies certain radial load, e.g., 30000 N; then the wheel continuously runs certain mileage under the load, e.g., 6000 km; and flaw detection is performed on the wheel after running the mileage.

The four-station road vehicle wheel radial fatigue test device can simultaneously test the radial fatigue on four single stations, thereby improving the test efficiency and reducing test devices.

### SUMMARY

The disclosure relates to a four-station road vehicle wheel radial fatigue test device and method.

Accordingly, the disclosure is aimed at providing a four-station road vehicle wheel radial fatigue test device and method, and the device has a loading function and is convenient to operate, simple in detection principle and structure, easy to manufacture and easy to promote and apply.

The four-station road vehicle wheel radial fatigue test device includes a drum, a drum driving device, wheel tire assemblies, wheel tire assembly supporting and loading devices, and a bracket.

Four sets of wheel tire assemblies and wheel tire assembly supporting and loading devices are provided, so that the running surface of the drum is sufficiently utilized and the test efficiency is increased.

The wheel tire assembly supporting and loading devices adopt a slide rail and slide block matching structure, and a servo motor is used as the driving device, so that the loading accuracy is improved.

The wheel tire assembly supporting and loading devices are installed in a manner that supporting shafts are perpendicular to the horizontal plane, thereby facilitating installation and removal of wheel and tire assemblies.

On a preferred aspect of the disclosure, the drum in the test device is installed perpendicular to the horizontal plane, thereby facilitating installation and maintenance and being more beneficial to enlarge the contact area with the wheel tire assemblies.

On a preferred aspect of the disclosure, an alternating-current servo adjustable speed motor is adopted as the drum driving device, so that the drum can be driven to rotate at a high speed, and a constant and adjustable rotating speed can be realized.

On a preferred aspect of the disclosure, the test device adopts a cross bracket, which is simple in structure and high in strength and enlarges the operating space.

A test method for the road vehicle wheel radial fatigue test device, including the following steps:

(1) wheel tire assemblies are installed onto corresponding wheel tire assembly supporting and loading devices; (2) a drum is started, and the drum rotating at a set rotating speed drives the wheel tire assembly supporting and loading devices in sequence, so that the wheel tire assemblies are forced to be in contact with the drum; and the wheel tire assemblies are driven to rotate by the drum, the radial load is gradually increased to a rated load, the wheel tire assembly supporting and loading devices are respectively provided with a force sensor, the magnitude of the load can be displayed and accurately controlled, at the moment, the loading process of the wheel tire assemblies is completed, and the drum drives the wheel tire assemblies to run continuously, till the test set running mileage ends.

The disclosure adopts four test stations, thereby improving the utilization rate of equipment, and improving the test efficiency. By adopting the vertical drum, the size and occupation area of the test device are reduced, and the wheel and tire assemblies are more convenient to install and remove. By adopting the servo motor as a power source for the drum and the wheel and tire assembly supporting and loading devices, the rotating speed and the load are easier to control, and the accuracy is higher. The wheel and tire assembly supporting and loading devices adopt a slide rail and slide block structure, so that the execution precision is high; and the loaded slide block mechanisms are provided with force sensors, and the axial directions of the sensors are consistent with the radial direction of the drum, thereby ensuring the accuracy of force transfer.

### BRIEF DESCRIPTION OF THE DRAWINGS

FIG. 1 is a schematic diagram of a four-station road vehicle wheel radial fatigue test device.

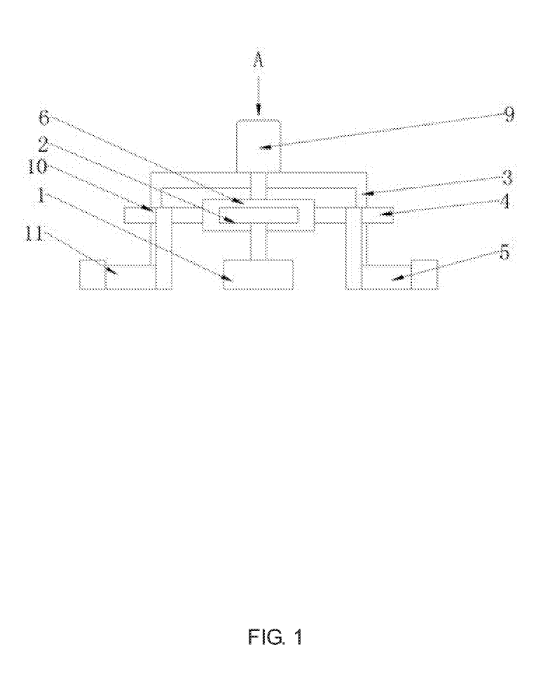

FIG. 2 is a schematic diagram of the four-station road vehicle wheel radial fatigue test device in the direction A.

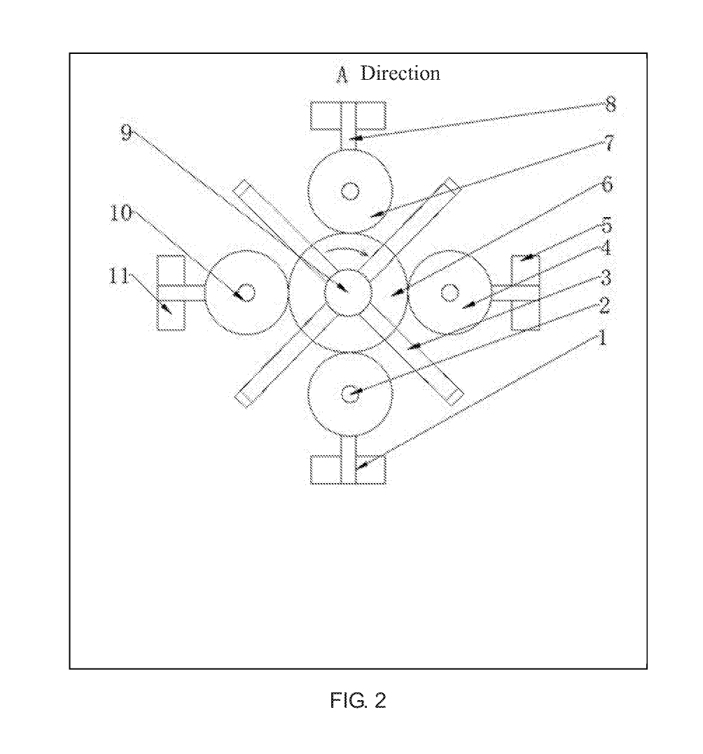

In which: 1-first wheel tire assembly supporting and loading device, 2-first wheel tire assembly, 3-bracket, 4-second wheel tire assembly, 5-second wheel tire assembly supporting and loading device, 6-drum, 7-third wheel tire assembly, 8-third wheel tire assembly supporting and loading device, 9-drum driving device, 10-fourth wheel tire assembly, 11-fourth wheel tire assembly supporting and loading device.

### DETAILED DESCRIPTION

A road vehicle wheel radial fatigue test device will be elaborated below in combination with the accompanying drawings.

The four-station road vehicle wheel radial fatigue test device includes a first wheel tire assembly supporting and loading device 1, a first wheel tire assembly 2, a bracket 3, a second wheel tire assembly, a second wheel tire assembly supporting and loading device 5, a drum 6, a third wheel tire assembly 7, a third wheel tire assembly supporting and loading device 8, a drum driving device 9, a fourth wheel tire assembly 10 and a fourth wheel tire assembly supporting and loading device 11.

The first wheel tire assembly supporting and loading device 1, the second wheel tire assembly supporting and loading device 5, the third wheel tire assembly supporting and loading device 8 and the fourth wheel tire assembly supporting and loading device 11 adopt a slide rail and slide block matching structure, and a servo motor is used as the driving device, so that the loading accuracy is improved.

The first wheel tire assembly supporting and loading device 1, the second wheel tire assembly supporting and loading device 5, the third wheel tire assembly supporting and loading device 8 and the fourth wheel tire assembly supporting and loading device 11 are installed in a manner that supporting shafts are perpendicular to the horizontal plane, thereby facilitating installation and removal of wheel and tire assemblies (2, 4, 7, 10).

On a preferred aspect of the disclosure, the drum 6 in the test device is installed perpendicular to the horizontal plane, thereby facilitating installation and maintenance and being more beneficial to enlarge the contact area with the wheel tire assemblies.

On a preferred aspect of the disclosure, an alternating-current servo adjustable speed motor is adopted as the drum driving device 9, so that the drum can be driven to rotate at a high speed, and a constant and adjustable rotating speed can be realized.

On a preferred aspect of the disclosure, the test device adopts a cross bracket 3, which is simple in structure and high in strength and enlarges the operating space.

A test method for the road vehicle wheel radial fatigue test device, including the following steps:

(1) wheel tire assemblies are installed onto corresponding wheel tire assembly supporting and loading devices; (2) a drum is started, and the drum rotating at a rotating speed of 500-2500 r/min drives the wheel tire assembly supporting and loading devices in sequence, so that the wheel tire assemblies are forced to be in contact with the drum; and the wheel tire assemblies are driven to rotate by the drum, the radial load is gradually increased to a rated load, the wheel tire assembly supporting and loading devices are respectively provided with a force sensor, the magnitude of the load can be displayed and accurately controlled, at the moment, the loading process of the wheel tire assemblies is completed, and the drum drives the wheel tire assemblies to run continuously, till the test set running mileage ends.

1. A four-station road vehicle wheel radial fatigue test device, including a drum, a drum driving device, wheel tire assemblies, wheel tire assembly supporting and loading devices, and a bracket, wherein four sets of wheel tire assemblies and wheel tire assembly supporting and loading devices are provided; and the wheel tire assembly supporting and loading devices adopt a slide rail and slide block matching structure and are installed in a manner that supporting shafts are perpendicular to the horizontal plane, the drum in the test device is installed perpendicular to the horizontal plane, and an alternating-current servo adjustable speed motor is adopted as the drum driving device.

2. The four-station road vehicle wheel radial fatigue test device of claim 1, wherein the test device adopts a cross bracket.

3. A test method for the road vehicle wheel radial fatigue test device, including the following steps:
(1) wheel tire assemblies are installed onto corresponding wheel tire assembly supporting and loading devices; (2) a drum is started, and the drum rotating at a set rotating speed drives the wheel tire assembly supporting and loading devices in sequence, so that the wheel tire assemblies are forced to be in contact with the drum; and the wheel tire assemblies are driven to rotate by the drum, the radial load is gradually increased to a rated load, the wheel tire assembly supporting and loading devices are respectively provided with a force sensor, the magnitude of the load can be displayed and accurately controlled, at the moment, the loading process of the wheel tire assemblies is completed, and the drum drives the wheel tire assemblies to run continuously, till the test set running mileage ends.
